(19) United States
(12) Patent Application Publication
(10) Pub. No.: US 2025/0170659 A1
(43) Pub. Date: May 29, 2025

(54) Rotating Bit with Integral Washer Feature

(71) Applicant: The Sollami Company, Herrin, IL (US)

(72) Inventor: Phillip Sollami, Herrin, IL (US)

(73) Assignee: The Sollami Company, Herrin, IL (US)

(21) Appl. No.: 18/059,662

(22) Filed: Nov. 29, 2022

Related U.S. Application Data
(63) Continuation-in-part of application No. 17/970,325, filed on Oct. 20, 2022, now abandoned.

(51) Int. Cl. B23B 51/12

(52) U.S. Cl. CPC B23B 51/12; B23B 2251/04

(57) ABSTRACT

A bit including a bit body and a shank depending from a bottom of the bit body. The bit body including an integral washer portion that extends to a rear annular flange and a tapered portion adjacent the rear annular flange. The tapered portion includes an angle that is complementary to an angle of a countersink at a forward end of a bore of a bit holder, such that the matching contacting angles of the tapered portion and the countersink radially align the bit concentric with the bore of the bit holder. The bit includes a retainer disposed circumferentially about the shank, allowing the bit to be securely mounted in the bore of the bit holder while still allowing the bit to freely rotate within the bore. The rear annular flange of the washer portion seats against a front face of the bit holder, forming a close coupling between the rear annular flange and the front face of the bit holder, allowing minimal space between the two surfaces and preventing cutting fines from migrating into the space between the outer diameter of the bit shank and the inner diameter of the retainer.

### CROSS-REFERENCE TO RELATED APPLICATION(S)

This application claims priority to and is a continuation-in-part of U.S. Non-provisional application Ser. No. 17/970,325, filed Oct. 20, 2022, to the extent allowed by law and the contents of which are incorporated herein by reference in their entireties. The contents of Applicant's co-pending U.S. Non-Provisional application Ser. No. 17/877,084, filed Jul. 29, 2022, Applicant's co-pending U.S. Non-Provisional application Ser. No. 17/146,992, filed Jan. 12, 2021, Applicant's U.S. Provisional Application No. 62/898,654, filed Sep. 11, 2019, Applicant's U.S. Provisional Application No. 62/965,237, filed Jan. 24, 2020, Applicant's U.S. Pat. No. 10,107,098, issued Oct. 23, 2018, and Applicant's U.S. Pat. No. 10,612,376, issued Apr. 7, 2020, are incorporated herein by reference in their entireties

### TECHNICAL FIELD

This disclosure relates to a bit and/or pick for road milling, mining, and trenching equipment, and more particularly, to a rotating bit including a washer feature.

### BACKGROUND

Road milling, mining, and trenching equipment utilizes bits and/or picks traditionally set in a bit assembly. Bit assemblies can include a bit and/or pick retained within a bore in a base block. Bit assemblies can also include a bit and/or pick retained by a bit holder and the bit holder retained within a bore in a base block. A plurality of the bit assemblies are mounted on the outside of a rotatable drum, typically in a V-shaped or spiral configuration. A plurality of the bit assemblies can also be mounted on an endless chain and plate configurations. The combinations of bit assemblies have been utilized to remove material from the terra firma, such as degrading the surface of the earth, minerals, cement, concrete, macadam or asphalt pavement. Individual bits and/or picks, bit holders, and base blocks may wear down or break over time due to the harsh road degrading environment. Additionally, the forces and vibrations exerted on the bit assemblies may cause the bit and/or pick to wear away the bore in the base block, the bit and/or pick to wear away the bore in the bit holder, or the bit holder to wear away the bore in the base block. For rotating bits, a slotted retainer, sleeve, and washer disposed circumferentially around the bit shank, for example, are used to maintain the bit in the bit holder. Over time, a gap forms between a bottom of the bit body and a forward face of the bit holder and the gap between a distal end of a sleeve and a forward end of a retainer continues to increase, allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a washer feature incorporated into the body of the bit and a slotted retainer with varying features adjacent a distal end of the retainer will ease the insertion of the bit into the bit holder, reduce costs, reduce axial movement, and form nearly 100 percent sealed areas between the inner diameter of the retainer and the outer diameter or the shank, between the bottom of the bit and the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block.

### SUMMARY

This disclosure relates generally to bit and/or pick assemblies for road milling, mining, and trenching equipment. One implementation of the teachings herein is a bit that includes a unitary body portion comprising a washer portion adjacent a distal end of the unitary body portion, the washer portion integrally formed as part of the unitary body portion; and a generally cylindrical shank depending from a bottom of the body portion.

In another implementation of the teachings herein is a bit and bit holder combination that includes a bit holder including a bit holder body portion comprising a front face at a forward end of the bit holder; a generally cylindrical hollow bit holder shank axially depending from a bottom of the bit holder body portion; and a bore axially extending from the front face of the bit holder body portion to a distal end of the bit holder shank; and a bit including a unitary bit body portion comprising a washer portion adjacent a distal end of the unitary body portion, the washer portion integrally formed as part of the unitary body portion; and a generally cylindrical bit shank depending from a bottom of the body portion, the bit shank disposed within the bore of the bit holder adjacent the front face of the bit holder.

These and other aspects of the present disclosure are disclosed in the following detailed description of the embodiments, the appended claims and the accompanying figures.

### BRIEF DESCRIPTION OF THE DRAWINGS

The various features, advantages, and other uses of the apparatus will become more apparent by referring to the following detailed description and drawings, wherein like reference numerals refer to like parts throughout the several views. It is emphasized that, according to common practice, the various features of the drawings are not to-scale. On the contrary, the dimensions of the various features are arbitrarily expanded or reduced for clarity.

FIG. 1 is a perspective view of a prior art bit and bit holder assembly;

FIG. 2 is a perspective view of the prior art bit and bit holder assembly;

FIG. 3 is a side elevation view of the prior art bit and bit older assembly;

FIG. 4 is a perspective view of a prior art washer;

FIG. 5 is an exploded view of the prior art bit and the prior art washer prior to assembly;

FIG. 6 is a side elevation view of the prior art bit and the prior art washer after assembly;

FIG. 7 is a side elevation view of the prior art bit assembled with the prior art washer and a prior art standard retainer;

FIG. 8 is a perspective view of the prior art bit shown assembled with the prior art washer and the prior art standard retainer;

FIG. 9 is a front elevation view of the prior art bit shown assembled with the prior art washer and prior art standard retainer;

FIG. 10 is a cross-sectional detail view of Broken-Out Section A of FIG. 7;

FIG. 11 is a cross-sectional detail view of Broken-Out Section B of FIG. 7;

FIG. 12 is an elevation view of the prior art bit and bit holder assembly after some use;

FIG. 13 is an elevation view of a prior art bit and bit holder assembly after some use;

FIG. 14 is a perspective view of a first illustrated embodiment of a bit in accordance with implementations of this disclosure;

FIG. 15 is a perspective view of the first illustrated embodiment of the bit in accordance with implementations of this disclosure;

FIG. 16 is a side elevation view of the first illustrated embodiment of the bit in accordance with implementations of this disclosure;

FIG. 17 is a distal end elevation view of the first illustrated embodiment of the bit in accordance with implementations of this disclosure;

FIG. 18 is a forward end elevation view of the first illustrated embodiment of the bit in accordance with implementations of this disclosure;

FIG. 19 is a perspective view of a second illustrated embodiment of a bit in accordance with implementations of this disclosure;

FIG. 20 is a perspective view of the second illustrated embodiment of the bit in accordance with implementations of this disclosure;

FIG. 21 is a side elevation view of the second illustrated embodiment of the bit in accordance with implementations of this disclosure;

FIG. 22 is an exploded side elevation view of a third illustrated embodiment of a bit, including a second illustrated embodiment of a retainer, in accordance with implementations of this disclosure;

FIG. 23 is a side elevation view of the third illustrated embodiment of the bit, shown assembled with the second illustrated embodiment of the retainer, in accordance with implementations of this disclosure;

FIG. 24 is a perspective view of the first illustrated embodiment of the bit, shown assembled with a first illustrated embodiment of a retainer, in accordance with implementations of this disclosure;

FIG. 25 is a perspective view of the first illustrated embodiment of the bit, shown assembled with the first illustrated embodiment of the retainer, in accordance with implementations of this disclosure;

FIG. 26 is a side elevation view of the first illustrated embodiment of the bit, shown assembled with the first illustrated embodiment of the retainer, in accordance with implementations of this disclosure;

FIG. 27 is a distal end elevation view of the first illustrated embodiment of the bit, shown assembled with the first illustrated embodiment of the retainer, in accordance with implementations of this disclosure;

FIG. 28 is a forward end elevation view of the first illustrated embodiment of the bit, shown assembled with the first illustrated embodiment of the retainer, in accordance with implementations of this disclosure;

FIG. 29 is a perspective view of the first illustrated embodiment of the bit, shown assembled with the first illustrated embodiment of the retainer, in accordance with implementations of this disclosure;

FIG. 30 is a perspective view of the first illustrated embodiment of the bit, shown assembled with the first illustrated embodiment of the retainer, showing the retainer gap fully open prior to assembly into a bit holder, in accordance with implementations of this disclosure;

FIG. 31 is a side elevation view of the first illustrated embodiment of the bit, assembled into a bore of the bit holder, accordance with implementations of this disclosure;

FIG. 32 is a cross-sectional view of the first illustrated embodiment of the bit, assembled into the bore of the bit holder, taken along Line A-A of FIG. 31 in accordance with implementations of this disclosure;

FIG. 33 is a side elevation view of the first illustrated embodiment of the bit, shown assembled with the first illustrated embodiment of the retainer, in accordance with implementations of this disclosure;

FIG. 34 is an exploded side elevation view of a first illustrated embodiment of a bit assembly, including the first illustrated embodiment of the bit, the first illustrated embodiment of the retainer, the bit holder, and a base block, in accordance with implementations of this disclosure;

FIG. 35 is an exploded side elevation view of the first illustrated embodiment of the bit assembly, showing the first illustrated embodiment of the bit assembled with the first illustrated embodiment of the retainer and the bit holder assembled with the base block, in accordance with implementations of this disclosure;

FIG. 36 is a rear elevation view of the first illustrated embodiment of the bit assembly in accordance with implementations of this disclosure;

FIG. 37 is a cross-sectional view of the first illustrated embodiment of the bit assembly taken along Line B-B of FIG. 36 in accordance with implementations of this disclosure;

FIG. 38 is a cross-sectional view of the first illustrated embodiment of the bit assembly taken along Line B-B of FIG. 36 in accordance with implementations of this disclosure;

FIG. 39 is a detail cross-sectional view of Detail C of the first illustrated embodiment of the bit assembly of FIG. 38 in accordance with implementations of this disclosure;

FIG. 40 is a cross-sectional view of the first illustrated embodiment of the bit assembly taken along Line B-B of FIG. 36 in accordance with implementations of this disclosure;

FIG. 41 is a detail cross-sectional view of Detail D of the first illustrated embodiment of the bit assembly of FIG. 40 in accordance with implementations of this disclosure;

FIG. 42 is an exploded side elevation view of a first illustrated embodiment of a bit holder and base block assembly and the first illustrated embodiment of the bit assembled with the first illustrated embodiment of the retainer, prior to assembly with a cutter bit cup holder and a pneumatic hammer, in accordance with implementations of this disclosure;

FIG. 43 is an exploded side elevation view of the first illustrated embodiment of the bit holder and base block assembly and the first illustrated embodiment of the bit, shown at the beginning of the insertion process with the cutter bit cup holder and pneumatic hammer, in accordance with implementations of this disclosure;

FIG. 44 is a side elevation view of a first embodiment of the bit assembly, shown after complete assembly with the cutter bit cup holder and pneumatic hammer of the first illustrated embodiment bit into the bit holder and base block assembly, in accordance with implementations of this disclosure;

FIG. 45 is an exploded side elevation view of the first illustrated embodiment of the bit holder and base block assembly and the first illustrated embodiment of the bit assembled with the first illustrated embodiment of the retainer, prior to assembly with a cutter bit manual holder and a manual hammer, in accordance with implementations of this disclosure;

FIG. 46 is an exploded side elevation view of the first illustrated embodiment of the bit holder and base block assembly and the first illustrated embodiment of the bit, shown at the beginning of the insertion process with the cutter bit manual holder and manual hammer, in accordance with implementations of this disclosure; and

FIG. 47 is a side elevation view of a first embodiment of the bit assembly, shown after complete assembly with the cutter bit manual holder and manual hammer of the first illustrated embodiment bit into the bit holder and base block assembly, in accordance with implementations of this disclosure.

### DETAILED DESCRIPTION

Road milling, mining, and trenching equipment utilizes bits and/or picks traditionally set in a bit assembly. Bit assemblies can include a bit and/or pick retained within a bore in a base block. For rotating bits, a slotted retainer, sleeve, and washer disposed circumferentially around the bit shank, for example, have typically been used to maintain the bit in the bit holder. Due to excess axial movement, however, gaps form between a bottom of the bit body, the washer, and a forward face of the bit holder and between a distal end of a sleeve and a forward end of a retainer, allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a washer feature incorporated into the body of the bit adjacent a distal end of the bit body, and a slotted retainer with varying features adjacent a distal end of the retainer will ease the insertion of the bit into the bit holder. The bit comprising the bit body including the integral washer feature of the present disclosure reduces the number of components that need to be manufactured and assembled, lowers manufacturing costs, allows faster manufacturing processes, provides more efficient bit performance, requires fewer bit replacements, and allows better bit rotation. Complete consumption of the usable carbide bit tip is possible due to the improved bit rotation and the larger and wider washer feature of the bit body. The integral bit body/washer design of the bit of the present disclosure decreases the number of components in the bit assembly, thereby allowing accurate, repeatable axial movement limits that are application specific.

The bit of the present disclosure also reduces axial movement and forms nearly 100 percent sealed areas between the inner diameter of the retainer and the outer diameter or the shank, between the bottom of the bit and the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block. The reduced axial movement of the bit body allows an angled portion at a distal end of the washer feature to engage an angle or countersink at a forward end of the bore of the bit holder. The axial movement of the bit of the present disclosure is less than the axial length of the angled portion at the distal end of the washer feature of the bit body of the bit.

After the bit is inserted into the bore of the bit holder, the retainer is axially fixed in place in a rearward seated position. The axial movement of the bit body is then strictly controlled by the allowable clearance between a forward shoulder of the bit shank and a distal shoulder of the bit shank and the overall length of the retainer. The maximum manufactured tolerance deviation between the dimensions of the forward shoulder and distal shoulder of the bit shank and the overall length of the retainer in the illustrated exemplary embodiments of the bit described herein is approximately 0.020 inch.

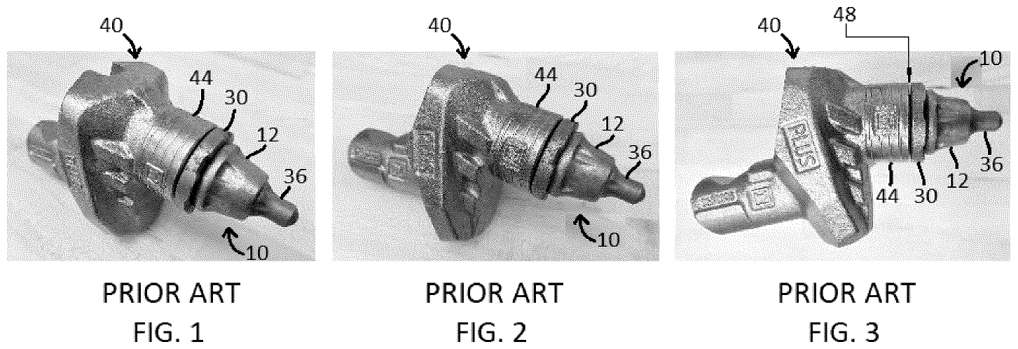

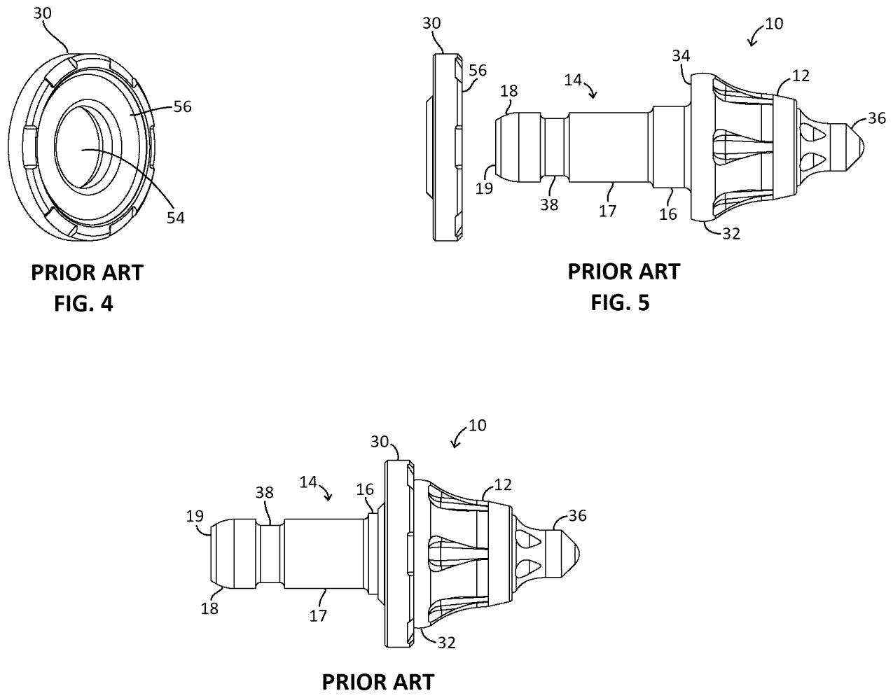

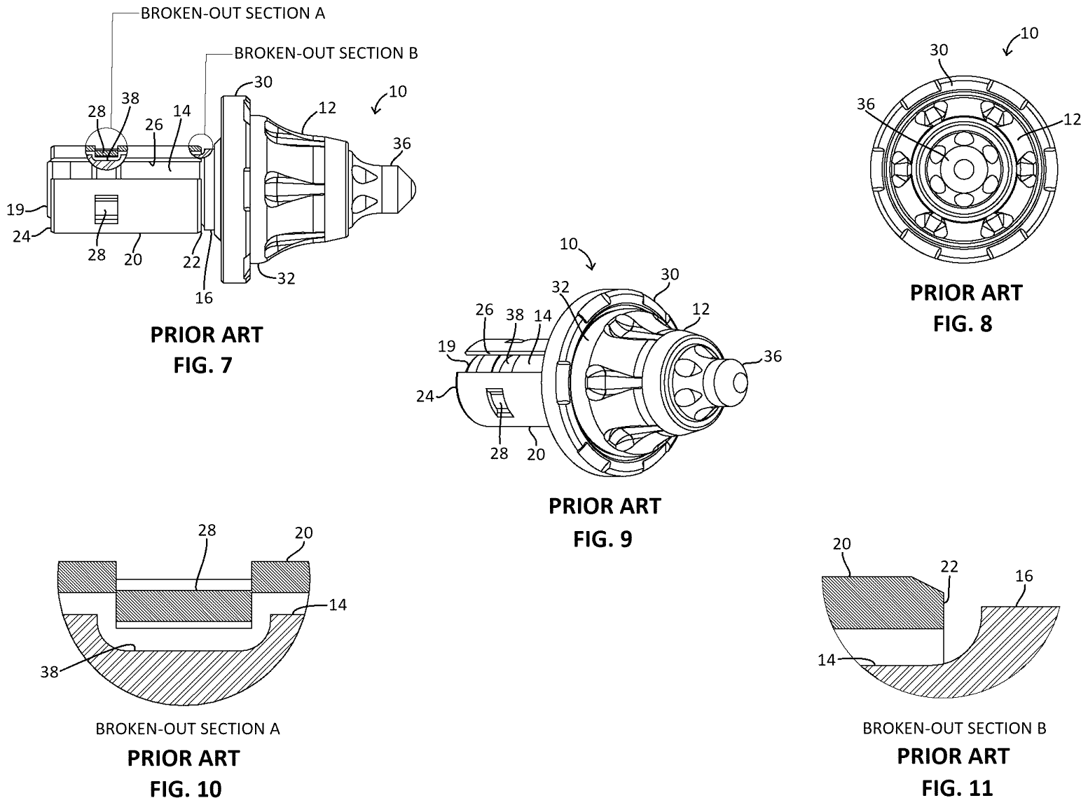

Referring to FIGS. 1-13, a prior art bit 10 is shown mounted into a bore (not shown) of a bit holder 40. The prior art bit 10 includes a bit body 12 and a bit shank 14 depending from a bottom of the bit body 12. The shank 14 includes a generally cylindrical forward portion 16 adjacent a forward end of the shank 14 that axially extends to a reduced diameter generally cylindrical mediate portion 17. The mediate portion 17 axially extends to an arcuate distal portion 18 of the shank 14 that extends to a distal end 19 of the shank 14. A groove 38 is disposed circumferentially about the mediate portion 17 adjacent the distal end 19 of the shank 14.

A prior art retainer 20, which includes a slot 26 extending from a forward end 22 of the retainer 20 to a distal end 24 of the retainer 20, is disposed around the shank 14 of the bit 10. The retainer 20 includes at least one radially inwardly extending tab 28 adjacent the distal end 24 of the retainer 20. Assembly of the bit 10 requires a two-step process. First, the retainer 20 is assembled onto the bit shank 14. When the retainer 20 is mounted onto the shank 14 of the bit 10, the at least one tab 28 engages the groove 38 of the mediate portion 17 of the bit shank 14 to prevent the retainer 20 from being removed from the shank 14 when the bit 10 is extracted from a bore 42 of a bit holder 40. Second, once the retainer 20 is mounted, a washer 30 is pre-assembled onto the retainer 20 to pre-compress the retainer 20 and allow for easier insertion of the bit shank 14 into the bore 42 of the bit holder 40 that is mounted into a bore of a base block (not shown).

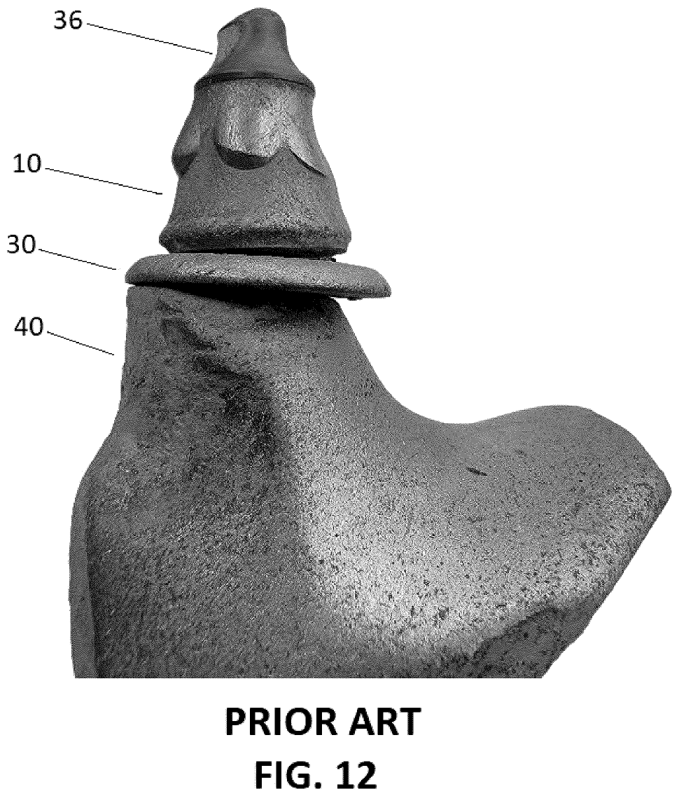

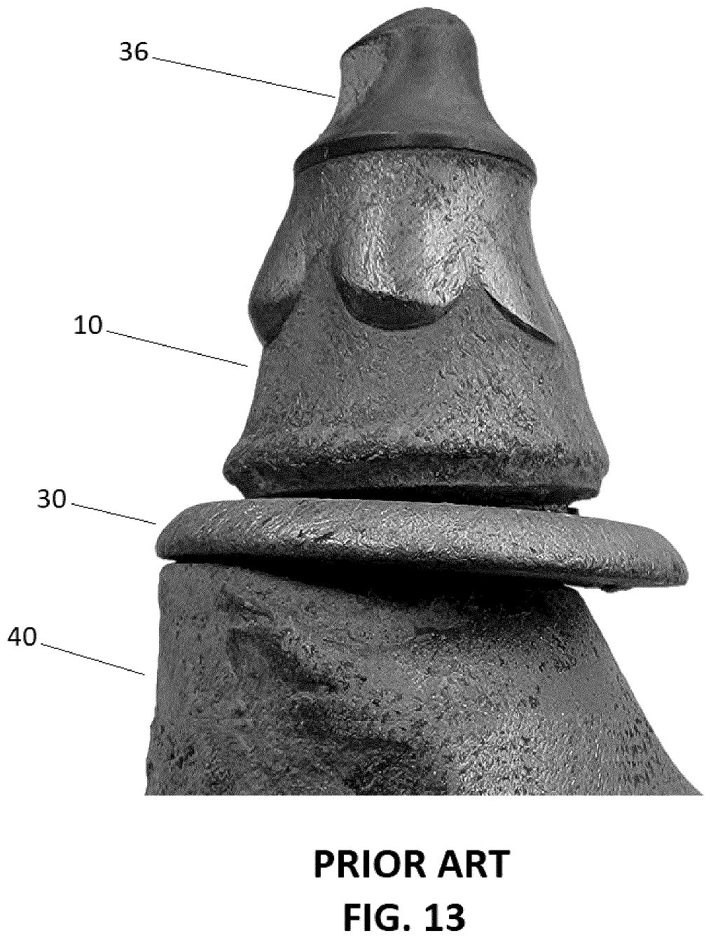

As the bit assembly, comprising the bit 10, is put to use, the bit body 12 moves axially away from its seated position against the face of the bit holder 40 when not in the cut, shown in FIGS. 1-3, 12, and 13, due to the centrifugal radial force of a rotating drum. An obvious space develops due to excessive axial and radial movement even when used in a new bit holder with current designs of milling bit assemblies that allow cutting fines to enter the gap between the outer diameter of the cutter bit shank 14 and the inner diameter of the retainer 20, which will in turn restrict bit rotation. As shown in FIGS. 12 and 13, the cutter bit shank 14 is located concentric to the bore of the bit holder 40. The washer 30 typically will cause a forward face 46 of the bit holder 40 to wear away at an angle to the centerline of the bore of the bit holder 40 because the washer 30 rotates independently from the rotation of the bit body 12.

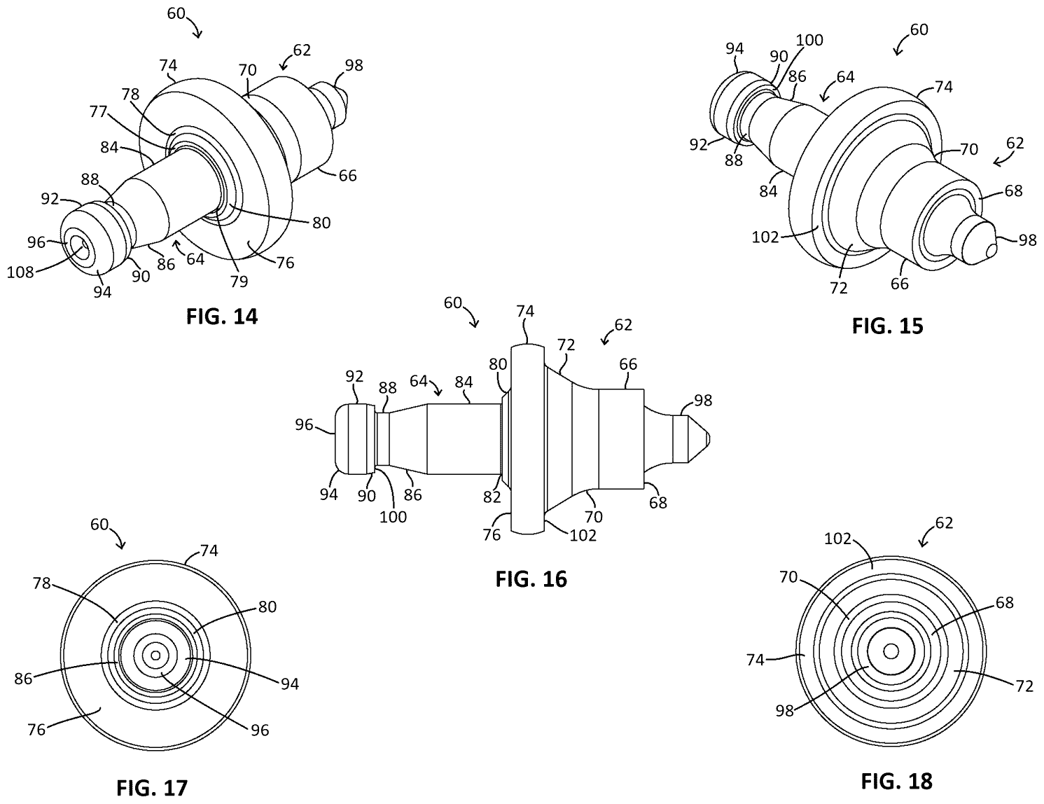

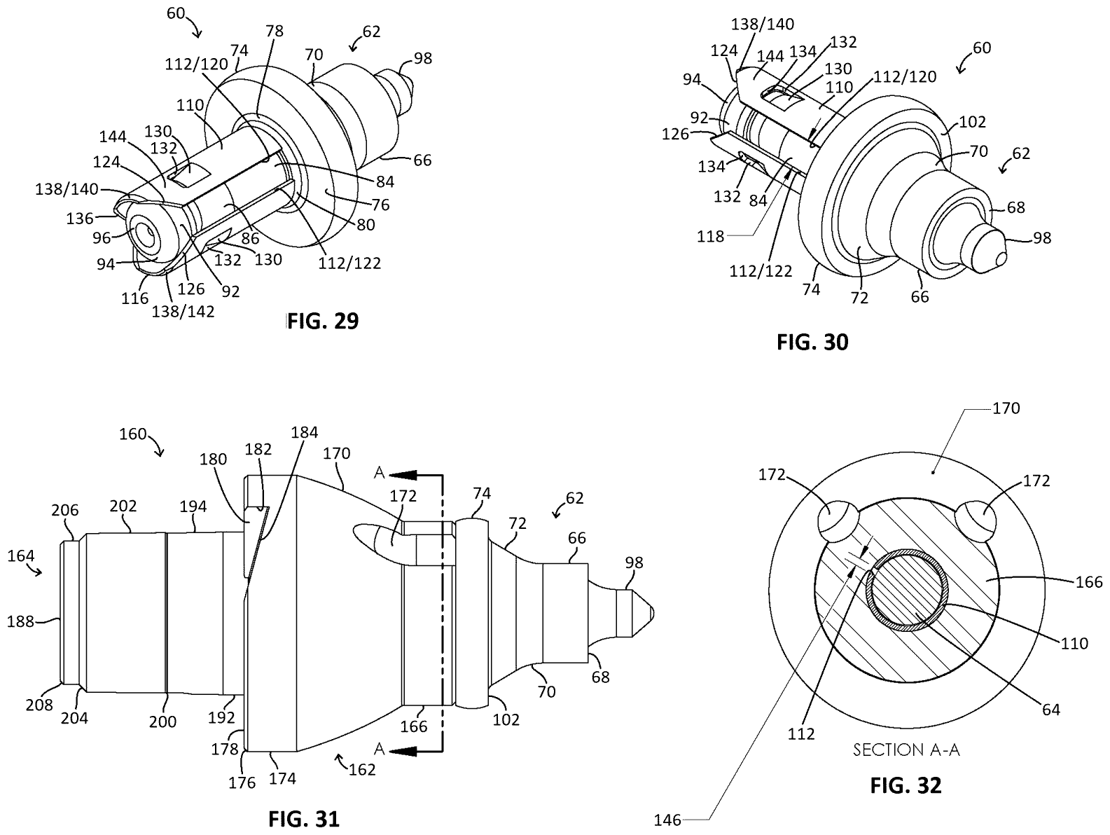

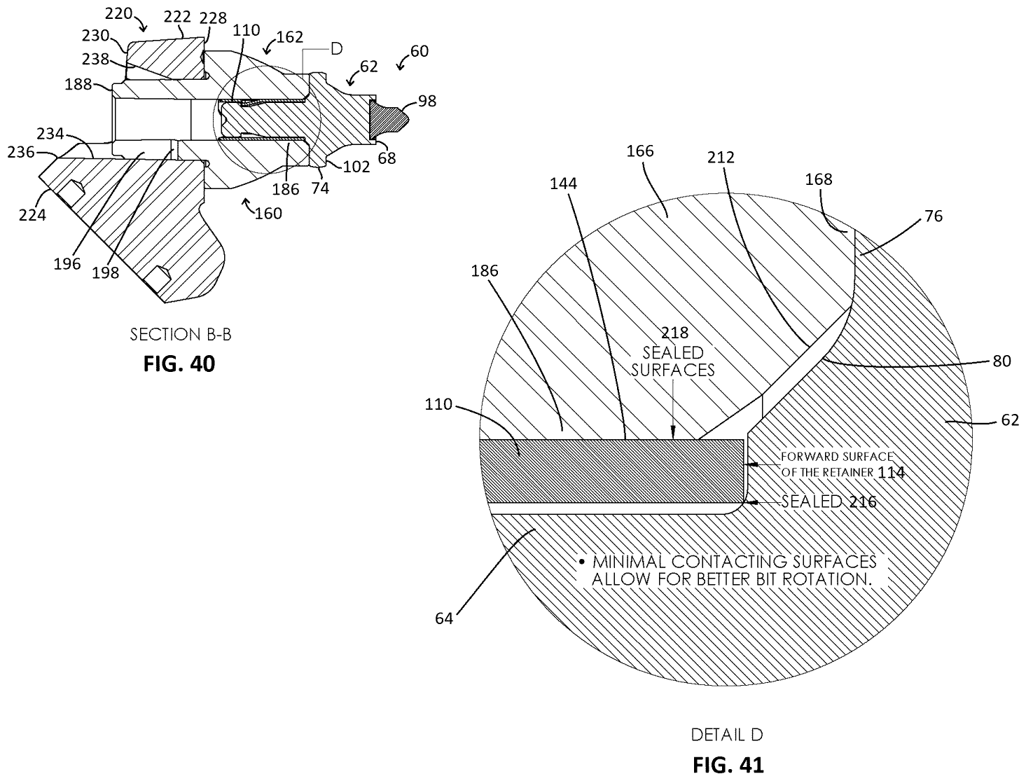

Referring to FIGS. 14-18 and 24-47, a first illustrated embodiment of a bit 60 comprises a bit body 62 and a bit shank 64 axially depending from a bottom of the bit body 62. The bit body 62 is generally cylindrical or generally annular in shape and comprises an annular or generally cylindrical top surface 68, such as a nearly flat annular top surface in the first illustrated embodiment, adjacent to an annular or generally cylindrical upper body portion 66 that includes an annular or generally cylindrical trough (not shown) in which to retain a bit tip 98. An arcuate or concave body portion 70 adjacent the upper body portion 66 generally slopes axially and radially outwardly to an angular or conical body portion 72. The angular body portion 72 extends axially to a forward surface 102 of a radially extending generally arcuate enlarged washer feature or portion 74.

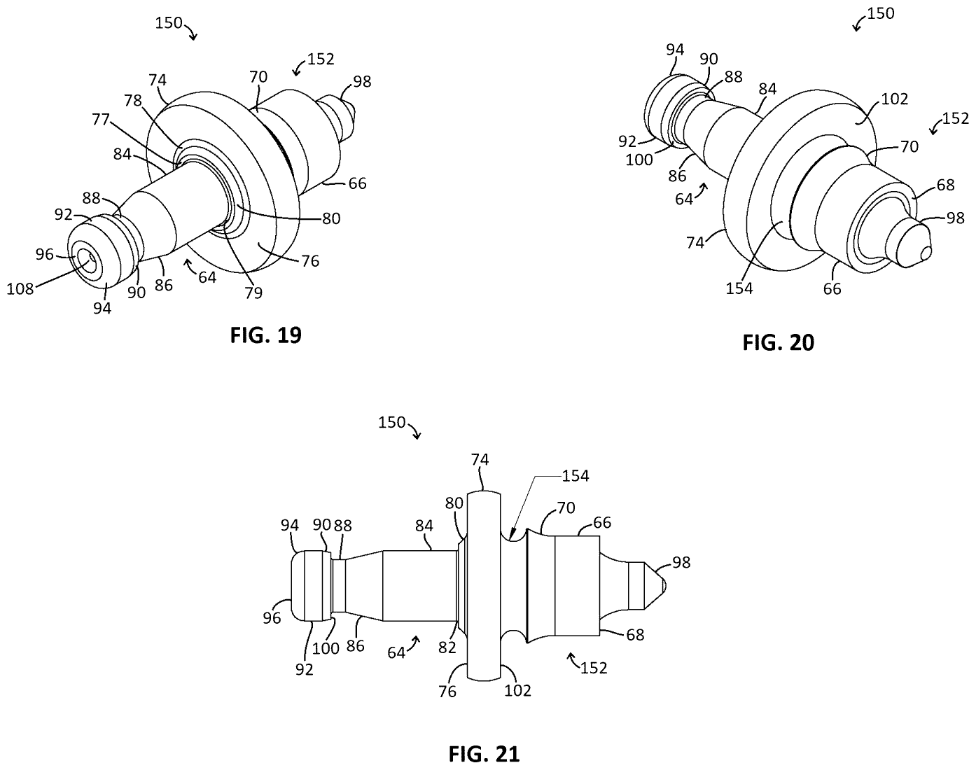

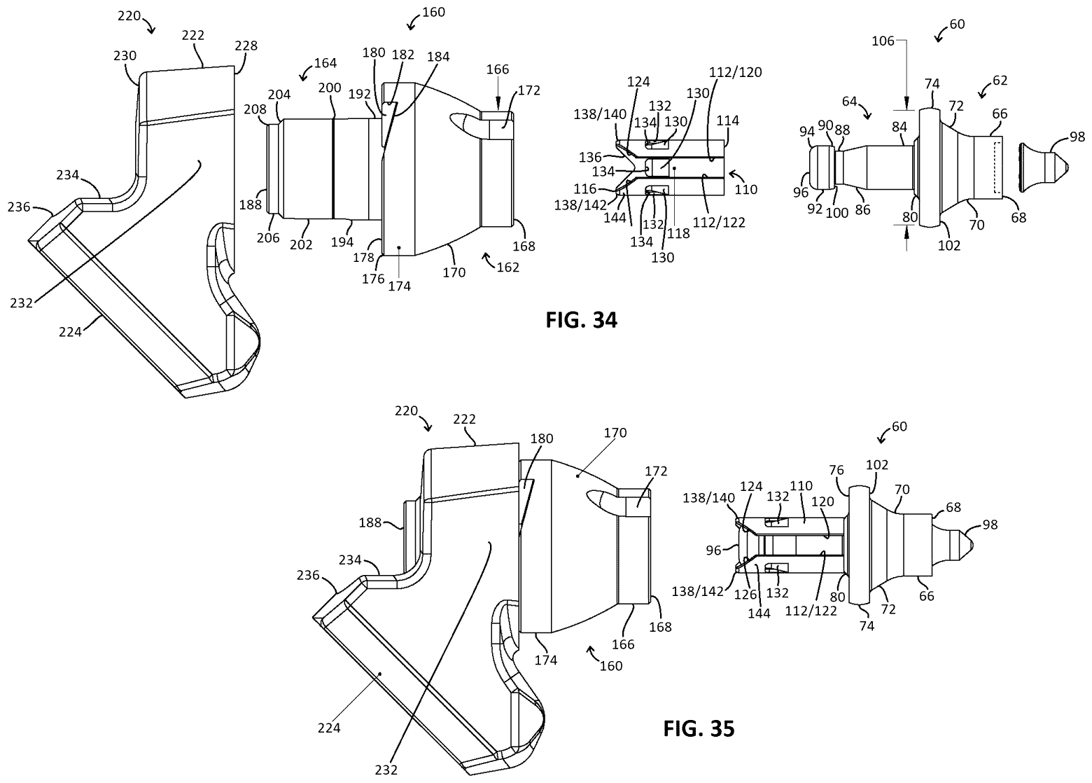

The washer feature 74 comprises a diameter 106 (FIG. 34) that, in this illustrated exemplary implementation, is generally the same as a diameter of a nose portion 166 of a bit holder 160. In other embodiments, the diameter of the washer feature 74 can be at least the diameter of the nose portion 166 of the bit holder 160 or greater than the diameter of the nose portion 166 of the bit holder 160. A decreased diameter tapered distal portion 80 extends from a first flange 76 of the washer feature 74 to a second flange 77 (FIGS. 14 and 19) at a forward end 82 of the shank 64. In this illustrated exemplary implementation, the thickness or axial length of the washer feature 74, measured from the first flange 76 to the forward surface 102 of the washer feature 74, is generally from about 3/16 inch to ½ inch and is application specific. The first flange 76 and the second flange 77 may be flat, annular, and/or generally cylindrical flanges. The first flange 76 includes a transition radius 78 laterally adjacent a forward end of the tapered distal portion 80. Transition radius 78 is a small radius that transitions from the rear annular flange 76 to the tapered distal portion 80. The second flange 77 also includes a transition radius 79 (FIGS. 14 and 19) laterally adjacent a forward end 82 of the bit shank 64. Transition radius 79 is also a small radius that transitions from the second flange or shoulder 77 to the shank 64.

A unibody is formed in that the washer feature 74 is designed as part of the bit body 62. When the washer feature 74 is incorporated into the bit body 62 as a single component design, the cost of the unibody, i.e., the washer feature 74 and the bit body 62 combination, is about 20% less cost than the two-part washer 30 and cutter bit body 12 configuration of the prior art.

The bit shank 64, shown in FIGS. 14-18, 24-26, 29, 30, 33-35, 37, and 39, axially depends from the transition radius 79 of the second flange 77 adjacent the decreased diameter tapered distal portion 80 of the washer feature 74 and is axially aligned with the bit body 62. The shank 64 comprises a generally cylindrical first segment 84 that axially extends from the transition radius 79 of the second flange 77 to a tapered second segment 86. The second segment 86 axially extends from the first segment 84 to a generally cylindrical third segment 88. The third segment 88 axially extends from the second segment 86 to a third flange 100. An outwardly tapered fourth segment 90, adjacent the third flange 100, axially extends to a generally cylindrical fifth segment 92. The fifth segment 92 axially extends to an arcuate sixth segment 94 that is adjacent to a distal end 96 of the shank 64. The shank 64 includes a notch 108 (FIGS. 14 and 19) that extends inwardly from the distal end 96. In other embodiments, the shank 64 can be cylindrical and/or can include tapered and/or arcuate segments.

The shank 64 includes a coaxial and generally cylindrical collapsible slotted retainer 110, described below, that is disposed circumferentially about the shank 64. The retainer 110 is generally made from spring steel or other hardenable material with an elasticity and a durability that allows the retainer 110 to return to its nearly original shape despite significant deflection or twisting.

Referring to FIGS. 19-21, a second illustrated embodiment of a bit 150 is substantially the same as the first illustrated embodiment of the bit 60 with an exception that a body 152 of the bit 150 includes a concave surface or groove 154 disposed between the arcuate or concave body portion 70 and the forward surface 102 of the washer feature 74. This groove 154 provides a space for a tool to extract the bit 150 from the bit holder 160.

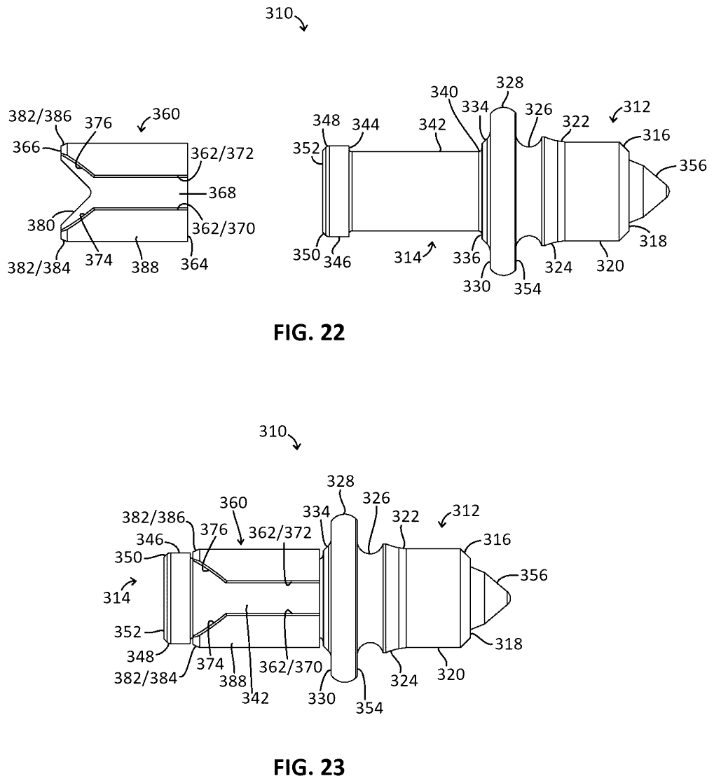

Referring to FIGS. 22 and 23, a third illustrated embodiment of a bit 310 comprises a bit body 312 and a bit shank 314 axially depending from a bottom of the bit body 312. The bit body 312 is generally cylindrical or generally annular in shape and comprises an annular or generally cylindrical top surface 318, such as a nearly flat annular top surface in the third illustrated embodiment, adjacent to an outwardly tapered or angular body portion 316 that includes an annular or generally cylindrical trough (not shown) in which to retain a bit tip 356. An annular or generally cylindrical upper body portion 320 axially extends to an arcuate or concave body portion 322. The arcuate or concave body portion 322 generally slopes axially and radially outwardly to an angular or conical body portion 324. A concave surface or groove 326, adjacent the angular body portion 324, extends axially to a forward surface 354 of a radially extending generally arcuate enlarged washer feature or portion 328.

The washer feature 328 comprises a diameter that, in this illustrated exemplary implementation, is generally the same as a diameter of the nose portion 166 of the bit holder 160. In other embodiments, the diameter of the washer feature 328 can be at least the diameter of the nose portion 166 of the bit holder 160 or greater than the diameter of the nose portion 166 of the bit holder 160. A decreased diameter tapered distal portion 334 extends from a first flange 330 of the washer feature 328 to a second flange 336 at the forward end 340 of the shank 314. In this illustrated exemplary implementation, the thickness or axial length of the washer feature 328, measured from the first flange 330 to the forward surface 354 of the washer feature 328, is generally from about 3/16 inch to ½ inch and is application specific. The first flange 330 and the second flange 336 may be flat, annular, and/or generally cylindrical flanges. The first flange 330 includes a transition radius (not shown) laterally adjacent a forward end of the decreased diameter tapered distal portion 334. The second flange 336 also includes a transition radius (not shown) laterally adjacent a forward end 340 of the bit shank 314.

A unibody is formed in that the washer feature 328 is designed as part of the bit body 312. When the washer feature 328 is incorporated into the bit body 312 as a single component design, the cost of the unibody, i.e., the washer feature 328 and the bit body 312 combination, is about 20% less cost than the two-part washer 30 and cutter bit body 12 configuration of the prior art.

The bit shank 314 axially depends from the transition radius of the second flange 336 adjacent the decreased diameter tapered distal portion 334 of the washer feature 328 and is axially aligned with the bit body 312. The shank 314 comprises a generally cylindrical first segment 342 that axially extends from the transition radius of the second flange 336 to a third flange 344 of the shank 314. A generally cylindrical second segment 346, adjacent the third flange 344, axially extends to an arcuate or convex third segment 348. The arcuate third segment 344 axially extends to an angular or tapered fourth segment 350 that is adjacent a distal end 352 of the bit shank 314. In other embodiments, the shank 314 can be cylindrical and/or can include tapered and/or arcuate segments.

The shank 314 includes a coaxial and generally cylindrical collapsible slotted retainer 360, described below, that is disposed circumferentially about the shank 314. The retainer 360 is generally made from spring steel or other hardenable material with an elasticity that allows the retainer 360 to nearly return to its original shape despite significant deflection or twisting.

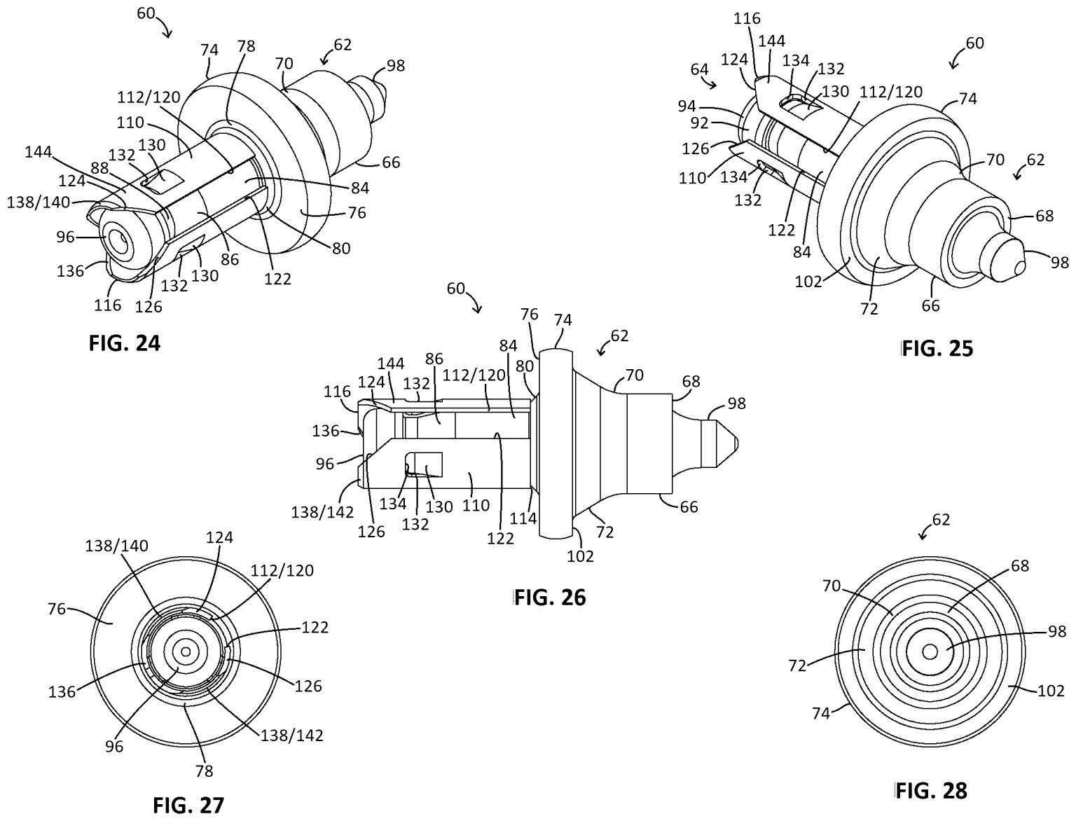

Referring to FIGS. 24-26, 29, 30, and 33-41, a first illustrated embodiment of the retainer 110 is shown in accordance with implementations of this disclosure. Retainer 110 includes a slot 112 axially extending from a forward end 114 of the retainer 110 to a distal end 116 of the retainer 110. The slot 112 comprises a gap profile 118 (FIG. 30) that is defined by a first radial end surface 120 of the slot 112 and a second radial end surface 122 of the slot 112. In this exemplary illustrated implementation, the radial end surfaces 120, 122 are linear throughout their axial length, thereby defining a linear gap profile 118. In alternate embodiments, the radial end surfaces 120, 122 and the gap profile 118 may be parallel, serpentine, arcuate, angular, zig-zagged, or any other configuration that can be formed by the radial end surfaces 120, 122 of the slot 112 or combination of same. This gap profile 118 is fully open prior to being inserted into a bore 186 of the bit holder 160. The retainer 110 comprises a first angled portion 124 that extends from the distal end 116 of the retainer 110 to the first radial end surface 120 of the slot 112 and a second angled portion 126 that extends from the distal end 116 of the retainer 110 to the second radial end surface 122 of the slot 112. A dual corner break is formed by the first angled portion 124 and the second angled portion 126, which allows for good and/or easier insertion of the distal end 116 of the retainer 110, disposed circumferentially about the shank 64 of the bit 60, into the bore 186 of the bit holder 160.

The retainer 110 includes a lead-in chamfer 138 that extends from the distal end 116 of the retainer 110 to an outer surface 144 of the retainer 110. The lead-in chamfer 138 allows about 50% less distal end 116 contact at a first contact surface 140 (FIGS. 22, 27, 28, 32, and 33) and a second contact surface 142 (FIGS. 26, 29, and 33-35) of the retainer 110 with the inner wall of the bore 186 of the bit holder 160, which is beneficial during the initial insertion of the retainer 110/shank 64 into the bore 186 of the bit holder 160. A narrow gap 146 is created within the gap profile 118 after the bit 60 with the attached retainer 110 is fully mounted in the bore 186 of the bit holder 160, as shown in FIG. 32.

The retainer 110 includes a radial relief notch 136, which is angular or v-shaped in this illustrated exemplary implementation, extending inwardly from the distal end 116 of the retainer 110. The lead-in chamfer 138 allows about 50% less distal end 116 contact at the first contact surface 140 and the second contact surface 142 of the retainer 110 with the inner wall of the bore 186 of the bit holder 160, which is beneficial during the initial insertion of the retainer 110 into the bore 186 of the bit holder 160. During insertion, the direction of collapse is radial, occurring initially adjacent the distal end 116 of the retainer 110. The addition of the relief notch 136, combined with lead-in chamfer and the dual opposite corner break formed by the first angled portion 124 and the second angled portion 126, allows for easier insertion of the distal end 116 of the retainer 110 into the bore 186 of the bit holder 160. In other embodiments, the retainer may include any of or any combination of the dual corner break, the lead-in chamfer 138, the relief notch 136, and/or compression slots.

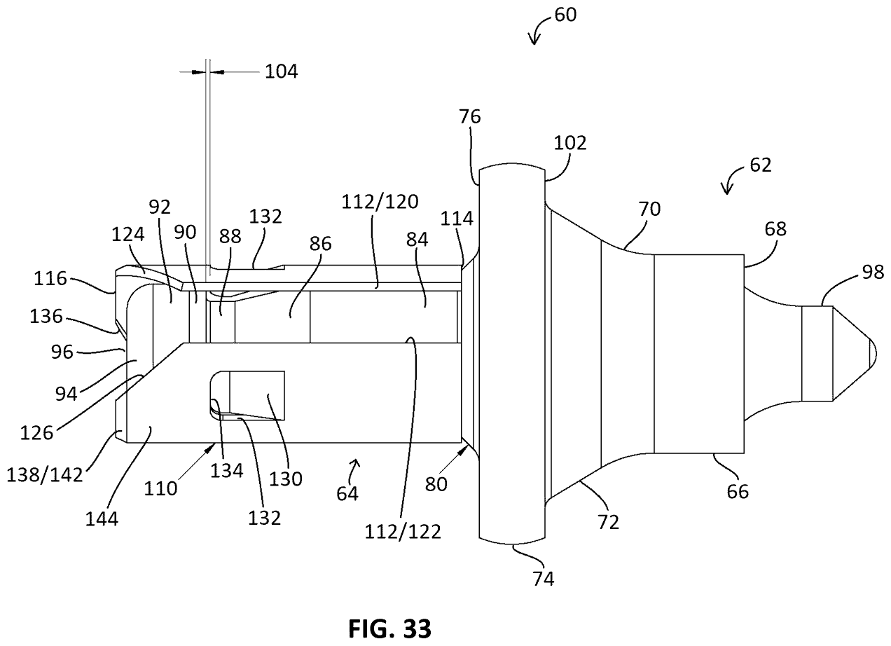

The retainer 110 also comprises at least one axially and radially inwardly extending axial locator tab 130 that is a predetermined distance from the distal end 116 of the retainer 110. The at least one tab 130 is radially inwardly positioned on a portion of the retainer 110 and forms a tab aperture 132 on the wall of the retainer 110 that terminates at a distal end 134 of the tab aperture 132. The at least one tab 130 is adapted to engage the recess or flange 100 adjacent the distal end 96 of the bit shank 64 to prevent the retainer 110 from being removed from the shank 64 when the bit 60 is extracted from the bore 186 of the bit holder 160. Additionally, the at least one tab 130 ensures that the axial movement 104 (FIG. 33) of the bit shank 64 is less than the axial length of the angular portion 80 extending from the rear annular flange 76 of the bit body 62. In this illustrated exemplary implementation, the ideal axial movement of the bit body 62 is limited to 0.040 inch or less.

In the exemplary illustrated embodiment described herein, the retainer includes three axially and radially inwardly extending tabs 130. In other embodiments, the retainer can include any number of axially and radially inwardly extending tabs. In yet another embodiment, the retainer can comprise at least one aperture (not shown) that is a predetermined distance from the distal end of the retainer. In yet other embodiments, the retainer can simply comprise a generally cylindrical collapsible body portion and a slot that axially extends along the length of the retainer and creates a narrow gap between opposing sidewalls or radial end surfaces of the slot. The distal end of the retainer can include the standard square corner or square end surface or can include any of the distal end features as described in Applicant's co-pending U.S. Non-Provisional application Ser. No. 17/970,325, filed Oct. 20, 2022, the contents of which are incorporated herein by reference in its entirety. Additionally, the gap profile of the slot, defined by the opposing sidewalls of the slot, can include various possible configurations and/or combinations such as those described in Applicant's co-pending U.S. Non-Provisional application Ser. No. 17/970,325.

Referring again to FIGS. 22 and 23, a second illustrated embodiment of the retainer 360 is shown in accordance with implementations of this disclosure. Retainer 360 includes a slot 362 axially extending from a forward end 364 of the retainer 360 to a distal end 366 of the retainer 360. The slot 362 comprises a gap profile 368 (FIG. 22) that is defined by a first radial end surface 370 of the slot 362 and a second radial end surface 372 of the slot 362. In this exemplary illustrated implementation, the radial end surfaces 370, 372 are linear throughout their axial length, thereby defining a linear gap profile 368. In alternate embodiments, the radial end surfaces 370, 372 and the gap profile 368 may be parallel, serpentine, arcuate, angular, zig-zagged, or any other configuration that can be formed by the radial end surfaces 370, 372 of the slot 362 or combination of same. This gap profile 368 is fully open prior to being inserted into the bore 186 of the bit holder 160.

The retainer 360 comprises a first angled portion 374 that extends from the distal end 366 of the retainer 360 to the first radial end surface 370 of the slot 362 and a second angled portion 376 that extends from the distal end 366 of the retainer 360 to the second radial end surface 372 of the slot 362. A dual corner break is formed by the first angled portion 374 and the second angled portion 376, which allows for good and/or easier insertion of the distal end 366 of the retainer 360, disposed circumferentially about the shank 314 of the bit 310, into the bore 186 of the bit holder 160.

The retainer 360 includes a lead-in chamfer 382 that extends from the distal end 366 of the retainer 360 to an outer surface 388 of the retainer 360. The lead-in chamfer 388 allows about 50% less distal end 366 contact at a first contact surface 384 and a second contact surface 386 of the retainer 360 with the inner wall of the bore 186 of the bit holder 160, which is beneficial during the initial insertion of the retainer 360/shank 314 into the bore 186 of the bit holder 160. A narrow gap is created within the gap profile 388 after the bit 310 with the attached retainer 360 is fully mounted in the bore 186 of the bit holder 160.

The retainer 360 also includes a radial relief notch 380, which is angular or v-shaped in this illustrated exemplary implementation, extending inwardly from the distal end 366 of the retainer 360. The lead-in chamfer 382 allows about 50% less distal end 366 contact at the first contact surface 384 and the second contact surface 386 of the retainer 360 with the inner wall of the bore 186 of the bit holder 160, which is beneficial during the initial insertion of the retainer 360 into the bore 186 of the bit holder 160. During insertion, the direction of collapse is radial, occurring initially adjacent the distal end 366 of the retainer 360. The addition of the relief notch 380, combined with lead-in chamfer 382 and the dual opposite corner break formed by the first angled portion 374 and the second angled portion 376, allows for easier insertion of the distal end 366 of the retainer 360 into the bore 186 of the bit holder 160. In other embodiments, the retainer may include any of or any combination of the dual corner break, the lead-in chamfer 382, the relief notch 380, and/or compression slots.

The distal end 366 of the retainer 360 is adapted to engage the recess or flange 344 adjacent the distal end 352 of the bit shank 314 to prevent the retainer 360 from being removed from the shank 314 when the bit 310 is extracted from the bore 186 of the bit holder 160. Additionally, the distal end 366 of the retainer 360 ensures that the axial movement of the bit shank 314 is less than the axial length of the angular portion 334 extending from the rear annular flange 330 of the bit body 312. In this illustrated exemplary implementation, the ideal axial movement of the bit body 312 is limited to 0.040 inch or less.

In yet other embodiments, the retainer can simply comprise a generally cylindrical collapsible body portion and a slot that axially extends along the length of the retainer and creates a narrow gap between opposing sidewalls or radial end surfaces of the slot. The distal end of the retainer can include the standard square corner or square end surface or can include any of the distal end features as described in Applicant's co-pending U.S. Non-Provisional application Ser. No. 17/970,325, filed Oct. 20, 2022, the contents of which are incorporated herein by reference in its entirety. Additionally, the gap profile of the slot, defined by the opposing sidewalls of the slot, can include various possible configurations and/or combinations such as those described in Applicant's co-pending U.S. Non-Provisional application Ser. No. 17/970,325.

Referring to FIGS. 31, 32, and 34-41, a first embodiment of the bit holder 160 includes a bit holder body 162 and a shank 164 axially depending from the bottom of the bit holder body 162. The bit holder body 162 is generally annular in shape and comprises an annular or generally cylindrical upper body portion 166 axially extending from a top surface 168, such as a flat annular top surface. Subjacent the upper body portion 166 is a middle portion 170 that extends axially and radially outwardly to a radially extending generally cylindrical tire portion 174. The middle portion 170, in this illustrated embodiment, has an arcuate shape. In other embodiments, the middle portion 170 can have a frustoconical shape, a convex shape, or a concave shape and the tire portion 174 can have an arcuate shape.

Adjacent the tire portion 174 is a chamfer or tapered portion 176 that axially extends to a flange 178, such as a flat annular flange, of the bit holder body 162. The tire portion 174 includes a pair of tapered cutouts 180, or wedge-shaped undercuts, to provide access and leverage for a tool to extract the bit holder 160 from a base block 220. The tapered cutouts 180 are formed into the tire portion 174 and extend from the flange 178 adjacent to the tire portion 174. The tapered cutouts 180 include a pair of parallel flat vertical inner surfaces 182 and a pair of flat tapered top surfaces 184. The outer edge of the flat tapered top surfaces 184 is each arcuate in shape to follow the periphery of the tire portion 174. A pair of notches 172 are formed into the bit holder body 162 and extend from the flat annular top surface 168 through the upper body portion 166 and the middle portion 170, terminating at a point within the middle portion 170. The notches 172 provide access and leverage for a tool to extract, or knock out, a bit from the bit holder body 162.

The shank 164 axially depends from the flange 168 of the bit holder body 162. The bit holder body 162 and the shank 164 are axially aligned with the bit holder bore 186 that extends from a countersink 212 adjacent the flat annular top surface 168 of the bit holder body 162 to a distal end 188 of the shank 164. In this illustrated embodiment, the shank 164 includes a shortened 1½ inch length. In other embodiments, the shank 164 can include the standard 2⅝ inch length or other suitable length. In this illustrated embodiment, the shank 164 also includes a slot 196 that extends from an upper termination 198 in the decreased diameter mediate segment 194 to the distal end 188 of the shank 164. Optionally, or in an alternate embodiment, the shank 164 can also include an internally oriented slot (not shown) that can be located approximately 180 degrees around the annular shank 164 from the first slot 196. This second slot is parallel to the first slot 196 and is an internal slot having a rearward semicircular termination (not shown) inwardly adjacent to the distal end 188 of the shank 164 and a forward semicircular termination (not shown) generally coinciding longitudinally and axially with the upper termination 198 of the first slot 196.

The shank 164 comprises an increased diameter shortened top segment 192 that axially extends from a rounded junction 190 adjacent the flange 178 (FIGS. 31 and 34). A decreased diameter mediate segment 194 is adjacent to the increased diameter top segment 192. The decreased diameter mediate segment 194 can have a generally cylindrical shape, an arcuate shape, can be tapered towards the increased diameter top segment 192, or can be tapered towards the distal end 188 of the shank 164 as shown in this illustrated embodiment. The shank 164 also includes an annular shoulder 200 disposed between the decreased diameter mediate segment 194 and a lower segment 202. A diameter of the annular shoulder 200 increases, or steps up, as it axially extends from the decreased diameter mediate segment 194 to the lower segment 202. The lower segment 202, in this illustrated embodiment, may be tapered outwardly as it extends towards the distal end 188 of the shank 164. The lower segment 202 runs axially from the annular shoulder 200 to a stepped shoulder 204 adjacent the distal end 188 of the shank 164. The stepped shoulder 204 is disposed between the lower segment 202 and the distal end 188 of the shank 164. A diameter of the stepped shoulder 204 decreases, or steps down, as it axially extends from the lower segment 202 to a decreased diameter distal segment 206. The decreased diameter distal segment 206 axially extends from the stepped shoulder 204 to a chamfer or tapered portion 208 adjacent the distal end 188 of the shank 164 and is generally C-shaped when viewed from the distal end 188.

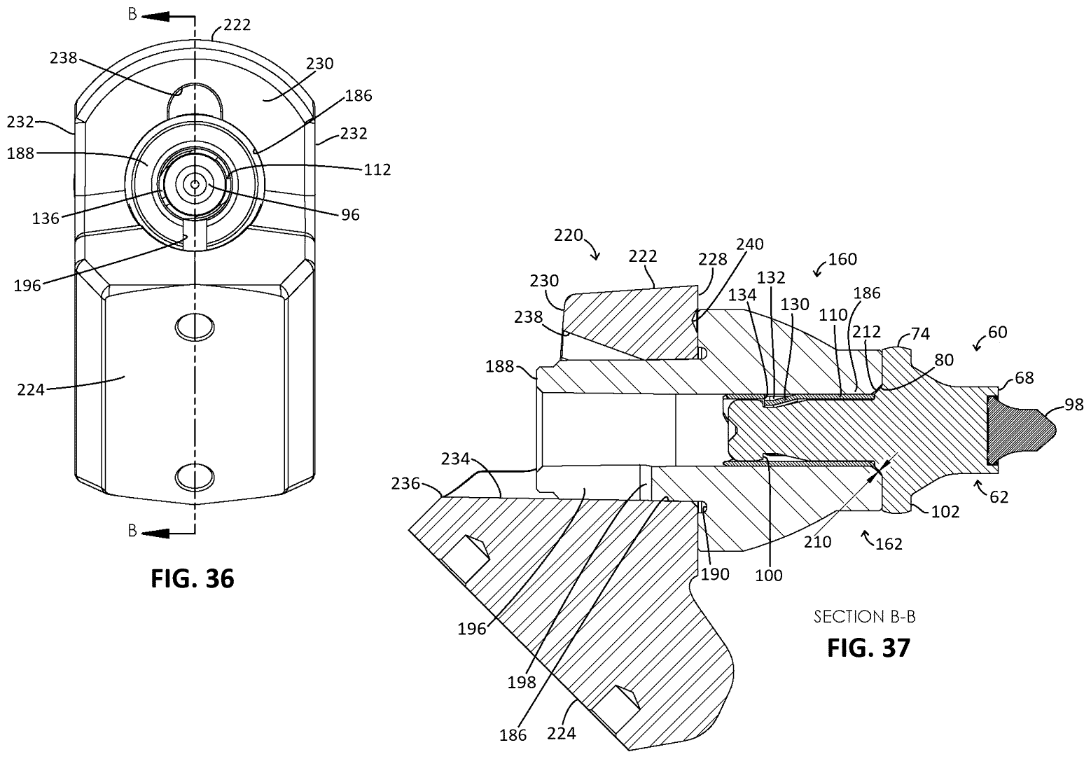

The base block 220 comprises a base 224 and a shortened front end or shortened bit holder receiving portion 222. The base 224 can be flat or slightly concave to fit a drum or additional mounting plates on which a singular or a plurality of base blocks can be mounted. The shortened front end 222 includes a base block bore 226, shown in FIGS. 36 and 37, that is symmetrical with the shank 64 along a centerline. The shortened front end 222 and the base block bore 226 extending axially through the shortened front end 222 are shortened to approximately 1.5 inches in length, in this embodiment, by removing material from the rear of the shortened front end 222. The shortened front end 222 includes, in this embodiment, an indentation 240 (FIG. 37) on a front face 228 of the base block 220. The shortened front end 222 also includes, in this embodiment, a slot 238 (FIGS. 36-38 and 40) decreasing in radial size from a rear face 230 of the shortened front end 222 to a position mediate the front face 228. The slot 238 provides added room for a punch (not shown) to operate and push the shank of a bit out of the bit holder. The shortened front end 222 also includes a pair of flat vertical sides 232, shown in FIGS. 34-36, that extend near and/or adjacent to the base 224. The flat vertical sides 232 reduce the dimensions of the base block 220 width and allow bit assemblies to be positioned in closer center-to-center axial bit tip orientation in order to degrade the road to a smoother surface.

The base block 220 also includes an arcuate bore 226 extension 234 (FIGS. 34, 35, 37, 38, and 40) starting at an inner portion of the base block bore 226 adjacent the rear face 230 of the shortened front end 222 and extending toward a rear 236 (FIGS. 34, 35, 37, 38, and 40) of the base block 220. The extension 234 does not serve a function when the base block 220 is used with a shortened shank bit holder 160. However, over time the extreme forces from cutting conditions will wear the base block bore 226 and bit holder shank 164 such that the shortened shank bit holder 160 may not successfully be retained in the base block bore 226 and the shortened shank bit holder 160 must be replaced with a standard 2⅝ inch length shank bit holder (not shown). The extension 234 engages the 2⅝ inch long shank of the standard bit holder adjacent its distal end and provides sufficient radial support against that portion of the shank to retain the standard bit holder in the base block bore 226.

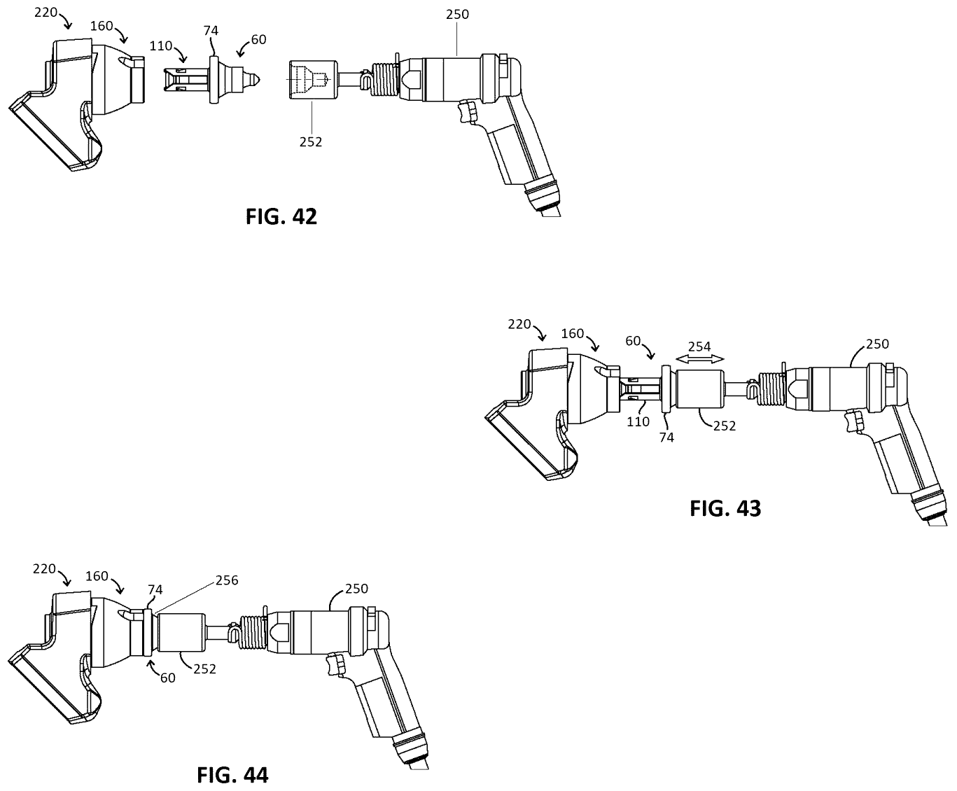

Referring to FIGS. 42-44, to mount the bit 60 into the bit holder 160 and base block 220 assembly, the shank 64 of the bit 60 is aligned with the bore 186 of the bit holder 160. A cutter bit cup holder 252 is attached to a forward end of a pneumatic hammer 250 and the cutter bit cup holder 252 is placed onto the body 62 of the bit 60 at the beginning of the cutter bit insertion process 254 as shown in FIG. 42. The pneumatic hammer 250 is activated until the shank 64 of the bit 60 is fully assembled 256 into the bore 186 of the bit holder 160 as shown in FIG. 44.

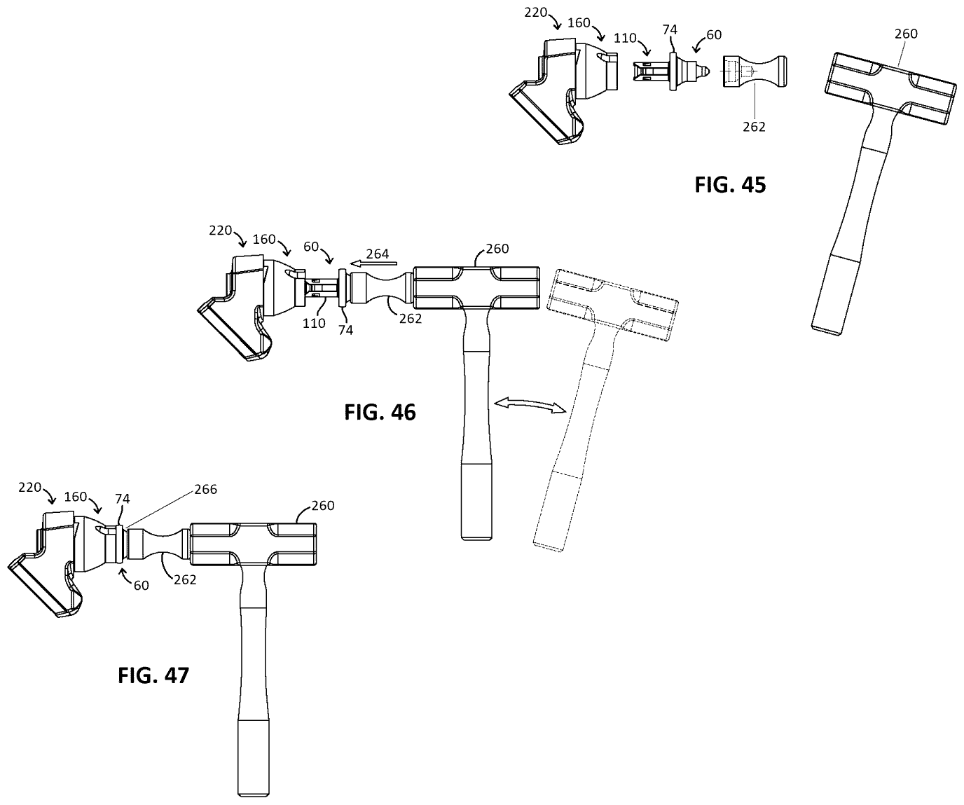

Referring to FIGS. 45-47, to mount the bit 60 into the bit holder 160 and base block 220 assembly, the shank 64 of the bit 60 is aligned with the bore 186 of the bit holder 160. A cutter bit manual holder 262 is placed onto the body 62 of the bit 60 in position for the insertion process 264 as shown in FIG. 46. A manual hammer 260 is used to drive the shank 64 of the bit 60 into the bore 186 of the bit holder 160 until the bit 60 is fully assembled 266 in the bore 186 of the bit holder 160 as shown in FIG. 47.

The radially collapsible angular notch or v-notch 136, 380 and the lead-in chamfer 138, 382 of retainer 110, 360, respectively, provides for easier insertion of the bit shank 64, 64, 314 into the bore 186 of the bit holder 160. After the bit 60, 150, 310 is inserted into the bore 186 of the bit holder 160, the retainer 110, 360 is axially fixed in place in a rearward seated position. The axial movement of the bit body 62, 152, 312 is then strictly controlled by the allowable clearance between the length of bit shank 64, 64, 314 shoulders or flanges 77, 100 and the overall length of the retainer 110, 360. The maximum manufactured tolerance deviation between the shoulder dimensions 77, 100 and the overall length of the retainer 110, 360 in the illustrated exemplary implementations of the bits 60, 150, 310 described herein is 0.020 inch. Additionally, the v-shaped notches 136, 380 at the distal end 116, 366 of retainer 110, 360, respectively, cut through the debris and cutting fines in the bore 186 of the bit holder 160 and allow better metal to metal contact between the outer diameter of the retainer 110, 360 and the inner diameter of the bore 186 of the bit holder 160 through sequential bit replacements.

When the bit 60, 150, 310 is fully assembled in the bore 186 of the bit holder 160, the tapered distal portion 80, 80, 334 of the bit 60, 150, 310, respectively, engages the countersink 212 of the base block 220 such that the complementary angles of the tapered distal portion 80, 80, 334 and the countersink 212 radially align the cutter bit 60, 150, 310, respectively, concentric with the bore 186 of the bit holder 160, as shown in FIGS. 37, 39, and 41. The reduced axial movement of the bit body 62, 152, 312 allows the angled portion 80, 80, 334 to engage the countersink 212 that is adjacent the forward end 168 of the bit holder 160.

The angles of the tapered distal portion 80, 80, 334 and the countersink 212 form contacting angles 210 (FIG. 37) after some use of the cutter bit 60, 302, 310. These contacting angles 210 show the wear pattern that progresses from a new bit and new bit holder configuration as the cutter bit is put to use. As the wear pattern progresses, the angle of tapered distal portion 80, 80, 334 will develop a wear pattern that makes contact with the adjacent angled mating surface of countersink 2121 and with the forward face 168 of the bit holder 160. This wear-in relationship between the tapered distal portion 80, 80, 334 and the countersink 212 can only occur when there is an integral bit body design that does not allow the washer to move separately to the bit body, i.e., the bit 60, 302, 310 comprising the integral washer feature of the present disclosure. In contrast, the bit body 12 of the bit 10 of the prior art with a separate washer 30 will eventually develop a wear pattern as shown in FIG. 13, which clearly illustrates a bit holder angular face wear that is greater than 90 degrees to the centerline of the bit holder bore.

The integral bit body/washer combination structure of bit 60, 302, 310 of the present disclosure eliminates the wear condition shown in FIG. 13. The integral bit body/washer structure includes the linear tire portion of the bit to be at least equal to or greater than the combination of the standard cutter bit tire width plus the washer width. The singular one piece design of the integral bit body/washer of the bit 60, 302, 310 of the present disclosure increases the cutter bit and bit holder life by at least 20 percent and provides for better bit rotation, 90 degree circumferential face contact of the forward face 168 of the bit holder 160 to the adjacent rear annular flange 76, 76, 330 of bit 60, 302, 310, longer bit life, and longer bit holder life due to the larger rear annular flange 76, 76, 330 of the bit body 62, 304, 312 contacting the full forward face 168 of the bit holder 168 and thereby reducing bit holder bore 186 wear.

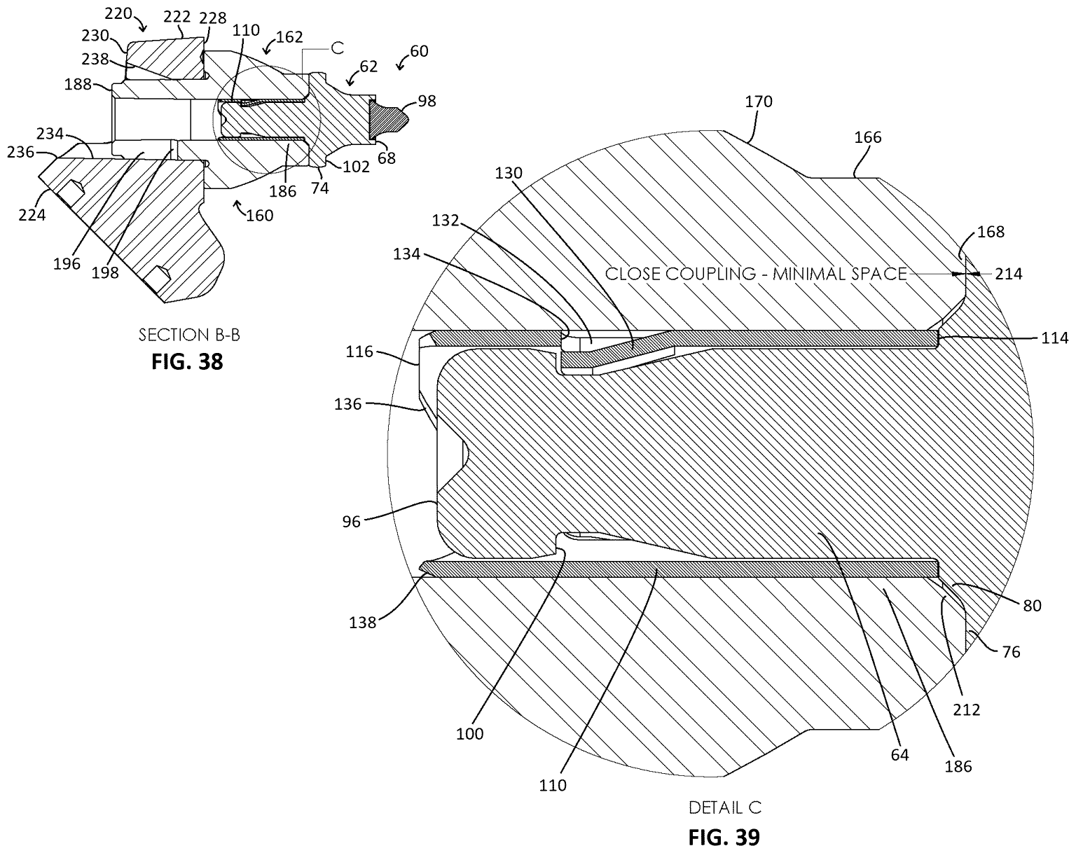

The unibody formed by the washer feature 74 and the bit body 62 combination provides for a close coupling, with minimal spacing and a nearly zero gap, between the rear annular flange 76 of the bit 60 and the front face 168 of the bit holder 160, as shown in FIG. 39, thereby preventing cutting fines from migrating into the outer diameter of the bit shank 64 and the inner diameter of the retainer 110. Additionally, a seal 216 formed between the tapered distal portion 80 and an inner portion of the forward end 114 of the retainer 110 and a seal 218 formed between the bore 186 of the bit holder 160 and the outer surface 144 of the retainer 110, shown in FIG. 41, provides for minimal contacting surfaces and allows better bit rotation. The two piece bit body and washer design of the bit of the prior art cannot achieve the same sealing characteristics of the integral bit body/washer design of the bits of the present disclosure. Additionally, the distal end features of the retainers described herein allow for easier insertion of the bit body retainer into the bore of the bit holder with a single impact of a hammer, thereby allowing additional impacts of the hammer to fully seat the bottom of the bit body of the bit on the forward face of the bit holder.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments and measurements, it is to be understood that the invention is not to be limited to the disclosed embodiments and measurements but, on the contrary, is intended to cover various modifications and equivalent arrangements included within the scope of the appended claims, which scope is to be accorded the broadest interpretation so as to encompass all such modifications and equivalent structures as is permitted under the law.

1. A bit comprising:
a unitary body portion comprising a washer portion adjacent a distal end of the unitary body portion, the washer portion integrally formed as part of the unitary body portion; and
a generally cylindrical shank depending from a bottom of the body portion.

2. The bit of claim 1, further comprising:
a tapered portion adjacent a rear annular flange of the washer portion, the tapered portion adapted to contact a countersink at a forward end of a bore of a bit holder to radially align the bit with the bore of the bit holder.

3. The bit of claim 2, the tapered portion comprising a first angle that is adapted to be complementary to a second angle of the countersink of the bore of the bit holder.

4. The bit of claim 2, further comprising:
a transition radius of the washer portion extending from the rear annular flange to the tapered portion.

5. The bit of claim 2, further comprising:
a transition radius of the tapered portion extending from a shoulder at a distal end of the tapered portion to a forward end of the shank.

6. The bit of claim 1, further comprising:
a rear annular flange of the washer portion adapted to form a close coupling with an annular surface at a forward end of a bit holder.

7. The bit of claim 1, further comprising:
a generally cylindrical hollow retainer disposed circumferentially about the shank.

8. The bit of claim 7, the retainer further comprising:
a first slot extending through a sidewall of the retainer from an axial forward end of the retainer to an axial distal end of the retainer;
a first angled portion extending from the axial distal end to a first radial end surface of the first slot; and
a second angled portion extending from the axial distal end to a second radial end surface of the first slot.

9. The bit of claim 8, the first angled portion and the second angled portion forming a dual corner break of the retainer adjacent the axial distal end of the retainer.

10. The bit of claim 8, further comprising:
a chamfer adjacent the axial distal end of the retainer, the chamfer extending to an outer surface of the retainer.

11. The bit of claim 8, further comprising:
a notch opposite the axial forward end of the retainer, the notch extending inwardly from the axial distal end of the retainer.

12. The bit of claim 11, further comprising:
a second slot axially extending from the notch through the sidewall of the retainer to a second slot termination, the second slot disposed approximately 180 degrees from the first slot.

13. The bit of claim 8, further comprising:
at least one tab disposed on the sidewall of the retainer, the at least one tab extending axially and radially inwardly, the at least one tab adapted to engage a flange on the shank of the bit to prevent the retainer from being removed from the shank.

14. The bit of claim 13, further comprising:
at least one tab aperture defined by the at least one tab; and
a second slot axially extending from the notch through the sidewall of the retainer to a distal end of one of the at least one tab apertures.

15. The bit of claim 11, wherein the notch is arcuate.

16. The bit of claim 8, further comprising:
an angular notch extending from the axial distal end of the retainer approximately 180 degrees from the first slot of the retainer.

17. The bit of claim 16, further comprising:
a first angled side of the angular notch extending from a first location at the axial distal end of the retainer to a vertex of the angular notch axially inward from the axial distal end of the retainer; and
a second angled side of the angular notch adjacent the first angled side, the second angled side extending from a second location at the axial distal end of the retainer to the vertex, the first location spaced from the second location at the axial distal end of the retainer.

18. The bit of claim 8, further comprising:
a gap profile of the retainer defined by the first radial end surface and the second radial end surface of the first slot.

19. The bit of claim 8, at least one of the first radial end surface and the second radial end surface of the first slot being at least one of linear, parallel, serpentine, arcuate, angular, and zig-zagged.

20. The bit of claim 18, the gap profile of the first slot being at least one of linear, parallel, serpentine, arcuate, angular, and zig-zagged.

21. A bit and bit holder combination comprising:
a bit holder comprising:
a bit holder body portion comprising a front face at a forward end of the bit holder;
a generally cylindrical hollow bit holder shank axially depending from a bottom of the bit holder body portion; and
a bore axially extending from the front face of the bit holder body portion to a distal end of the bit holder shank; and
a bit comprising:
a unitary bit body portion comprising a washer portion adjacent a distal end of the unitary body portion, the washer portion integrally formed as part of the unitary body portion; and
a generally cylindrical bit shank depending from a bottom of the body portion, the bit shank disposed within the bore of the bit holder adjacent the front face of the bit holder.

22. The bit and bit holder combination of claim 21, further comprising:
a tapered portion adjacent a rear annular flange of the washer portion.

23. The bit and bit holder combination of claim 22, the tapered portion comprising a first angle that is complementary to a second angle of the countersink of the bore of the bit holder.

24. The bit and bit holder combination of claim 22, the tapered portion of the washer portion contacting the countersink of the bore of the bit holder to radially align the bit with the bore of the bit holder.

25. The bit and bit holder combination of claim 22, further comprising:
a transition radius of the washer portion extending from the rear annular flange to the tapered portion.

26. The bit and bit holder combination of claim 22, further comprising:
an transition radius of the tapered portion extending from a shoulder at a distal end of the tapered portion to a forward end of the bit shank.

27. The bit and bit holder combination of claim 21, further comprising:
a rear annular flange of the washer portion forming a close coupling with an annular surface at a forward end of the bit holder

28. The bit and bit holder combination of claim 21, further comprising:
a generally cylindrical hollow retainer disposed circumferentially about the bit shank.

29. The bit and bit holder combination of claim 28, the retainer further comprising:
a first slot extending through a sidewall of the retainer from an axial forward end of the retainer to an axial distal end of the retainer;
a first angled portion extending from the axial distal end to a first radial end surface of the first slot; and
a second angled portion extending from the axial distal end to a second radial end surface of the first slot.

30. The bit and bit holder combination of claim 29, the first angled portion and the second angled portion forming a dual corner break of the retainer adjacent the axial distal end of the retainer.

31. The bit and bit holder combination of claim 29, further comprising:
a chamfer adjacent the axial distal end of the retainer, the chamfer extending to an outer surface of the retainer.

32. The bit and bit holder combination of claim 29, further comprising:
a notch opposite the axial forward end of the retainer, the notch extending inwardly from the axial distal end of the retainer.

33. The bit and bit holder combination of claim 32, further comprising:
a second slot axially extending from the notch through the sidewall of the retainer to a second slot termination, the second slot disposed approximately 180 degrees from the first slot.

34. The bit and bit holder combination of claim 39, further comprising:
at least one tab disposed on the sidewall of the retainer, the at least one tab extending axially and radially inwardly, the at least one tab adapted to engage a flange on the bit shank of the bit to prevent the retainer from being removed from the bit shank.

35. The bit and bit holder combination of claim 34, further comprising:
at least one tab aperture defined by the at least one tab; and
a second slot axially extending from the notch through the sidewall of the retainer to a distal end of one of the at least one tab apertures.

36. The bit and bit holder combination of claim 32, wherein the notch is arcuate.

37. The bit and bit holder combination of claim 29, further comprising:
an angular notch extending from the axial distal end of the retainer approximately 180 degrees from the first slot of the retainer.

38. The bit and bit holder combination of claim 37, further comprising:
a first angled side of the angular notch extending from a first location at the axial distal end of the retainer to a vertex of the angular notch axially inward from the axial distal end of the retainer; and
a second angled side of the angular notch adjacent the first angled side, the second angled side extending from a second location at the axial distal end of the retainer to the vertex, the first location spaced from the second location at the axial distal end of the retainer.

39. The bit and bit holder combination of claim 29, further comprising:
a gap profile of the retainer defined by the first radial end surface and the second radial end surface of the first slot.

40. The bit and bit holder combination of claim 29, at least one of the first radial end surface and the second radial end surface of the first slot being at least one of linear, parallel, serpentine, arcuate, angular, and zig-zagged.

41. The bit and bit holder combination of claim 39, the gap profile of the first slot being at least one of linear, parallel, serpentine, arcuate, angular, and zig-zagged.

42. The bit of claim 1, a diameter of the washer portion being at least a diameter of a front face of a bit holder at a forward end of the bit holder.

43. The bit and bit holder combination of claim 21, a diameter of the washer portion being at least a diameter of the front face of the bit holder.
